(19) United States
(12) Patent Application Publication
(10) Pub. No.: US 2006/0212149 A1
(43) Pub. Date: Sep. 21, 2006

(54) Distributed system and method for intelligent data analysis

(76) Inventors: Wendell T. Hicken, La Verne, CA (US); Marc E. Campbell, Monrovia, CA (US)

Correspondence Address: CHRISTIE, PARKER & HALE, LLP, PO BOX 7068, PASADENA, CA, 91109-7068, US

(21) Appl. No.: 11/388,863

(22) Filed: Mar. 24, 2006

Related U.S. Application Data
(63) Continuation-in-part of application No. 10/917,865, filed on Aug. 13, 2004.
(60) Provisional application No. 60/664,806, filed on Mar. 24, 2005.

(51) Int. Cl. G06F 17/00; G06F 15/16

(52) U.S. Cl. 700/94; 709/217

(57) ABSTRACT

A distributed system for intelligent data analysis includes a first computer device including a first data store storing first data content, a second computer device including a second data store storing second data content, and a central database coupled to the first and second computer devices over a data communications network. Each computer device identifies the data content stored in its data store, communicates with the central database for determining whether the central database includes analysis information for the identified data content, and responsive to a determination that the central database does not include the analysis information, processes the data content according to stored processing instructions and generates the analysis information. The analysis information is then uploaded to the central database over the data communications network.

This application claims the benefit of U.S. Provisional Application No. 60/664,806, filed on Mar. 24, 2005, and is a continuation-in-part of U.S. application Ser. No. 10/917,865, filed on Aug. 13, 2004 (attorney docket 52075), a continuation-in-part of U.S. application Ser. No. 10/668,926, filed on Sep. 23, 2003 (attorney docket 50659), a continuation-in-part of 10/278,636, filed on Oct. 23, 2002 (attorney docket 48763), and a continuation-in-part of U.S. application Ser. No. 11/236,274, filed on Sep. 26, 2005 (attorney docket 56161), which in turn is a continuation of U.S. application Ser. No. 09/556,051, filed on Apr. 21, 2000 (attorney docket 37273), the content of all of which are incorporated herein by reference.

### FIELD OF THE INVENTION

This invention relates generally to intelligent data analysis, and more specifically, to intelligent analysis of geographically disperse data content via distributed processing.

### BACKGROUND OF THE INVENTION

Automated systems for intelligent data analysis are desirable when there is a large amount of data to be analyzed, and/or because such systems are capable of analysis that humans are unable to conduct. Intelligent data analysis, however, generally requires that the analyzing computer have access to the data. Intelligent data analysis may also require a lot of processing power and time, which may not be available from a single computer. Accordingly, what is desired is a system and method that distributes the task of intelligent data analysis to various computers, especially computers that already have access to the data.

### SUMMARY OF THE INVENTION

The present invention is directed to a distributed system for intelligent data analysis that includes a first computer device including a first data store storing first data content and a second computer device including a second data store storing second data content. A central database is coupled to the first and second computer devices over a data communications network. Each computer device identifies the data content stored in its data store and communicates with the central database for determining whether the central database includes analysis information for the identified data content. Responsive to a determination that the central database does not include the analysis information, each computer device processes the corresponding data content according to stored processing instructions and generates corresponding analysis information. Each computer device then uploads the corresponding analysis information to the central database over the data communications network.

According to one embodiment of the invention, the data content is a musical piece, and the processing of the data content includes analyzing audio signals of the musical piece for generating a numerical measurement for each of a plurality of predetermined acoustic attributes.

According to another embodiment of the invention, the data content is a recipe, and the processing of the data content includes analyzing ingredients of the recipe for determining one or more chemical compositions and a numerical measurement of each of the one or more chemical compositions making up the ingredient.

According to other embodiments, the data content is lyrics of a particular song or an image.

According to another embodiment, the present invention is directed to a server coupled to a plurality of end devices in a distributed system for intelligent data analysis. The server includes a central data store, a processor, and a memory operably coupled to the processor, the memory storing program instructions for execution by the processor. The computer program instructions include receiving from a first requesting end device a first request including identification information identifying particular data content; responsive to the first request, searching the central data store for the identification information and determining whether the central data store includes analysis information for the particular data content; receiving from the first requesting end device analysis information for the particular data content responsive to a determination that that the central data store does not include the analysis information; and storing the received analysis information in the central data store.

According to one embodiment of the invention, the program instructions further include receiving from a second requesting end device a second request including the identification information identifying the particular data content; retrieving the analysis information from the central data store in response to the second request; and forwarding the analysis information to the second requesting device.

It should be appreciated that instead of requiring a single device to own and process all the data content, the task is distributed to multiple end devices for processing data that is already owned and stored at those devices. Furthermore, if the analysis has been performed by another device, a current device need not waste its processing power to repeat the analysis.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a block diagram of a distributed system for intelligent data analysis according to one embodiment of the invention;

FIG. 2 is a more detailed block diagram of a server in the system of FIG. 1 according to one embodiment of the invention;

FIG. 3 is a detailed block diagram of an end user device in the system of FIG. 1 according to one embodiment of the invention; and

FIG. 4 is a flow diagram of a process executed by a processor of the end device of FIG. 3 for populating a central database with intelligent content analysis according to one embodiment of the invention.

### DETAILED DESCRIPTION

In general terms, embodiments of the present invention are directed to distributing analysis of different data content to different end devices. Such data content may include, for example, music, recipes, lyrics, books, paintings, images, and the like. A user who already owns a copy of particular data content invokes his or her end device to automatically analyze that data content and upload the data content to a central repository. Once in the central repository, the analysis data may be made available for use by any requesting end device or server. The analysis data may be used, for example, to find other complementary data content.

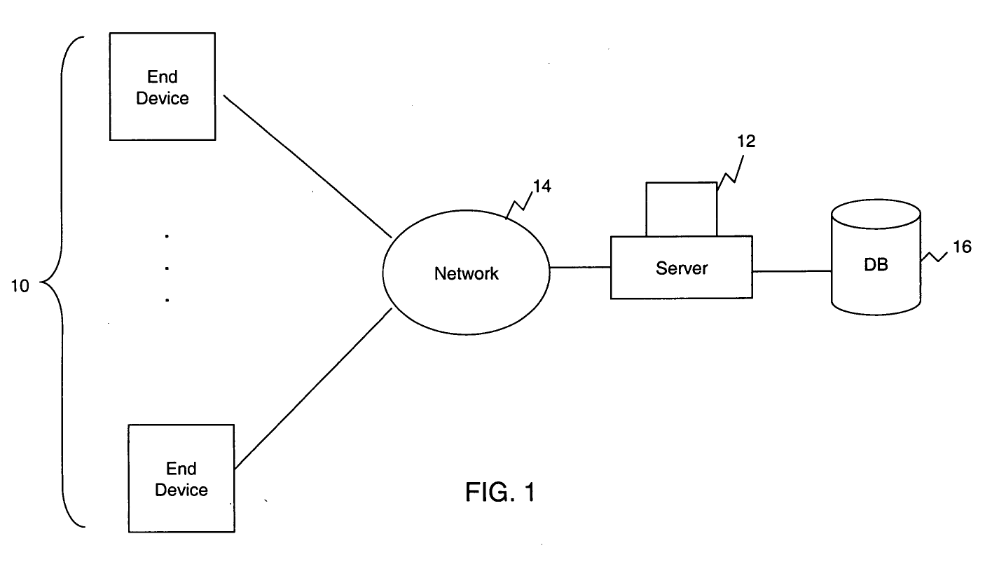

FIG. 1 is a block diagram of a distributed system for intelligent data analysis according to one embodiment of the invention. The system includes a plurality of end computer devices 10 coupled to a server 12 over a data communications network 14. The network may be any wired or wireless data communications network conventional in the art, such as, for example, a local area network, a private wide area network, the Internet, a cellular network, or the like. Any wired or wireless technology known in the art may be used to connect to the data communications network.

The end device 10 may be a personal computer, personal digital assistant (PDA), entertainment manager, car player, home player, portable player, portable phone, or any consumer electronics device known in the art.

According to one embodiment of the invention, the server 12 is coupled to a mass storage device that hosts a central database 16. The central database stores analysis data uploaded by the end devices 10. As such, the central database acts as a central repository of the analysis data. The uploaded data is then made available to other end devices or servers.

The central database 16 also stores identifier information for identifying the data content. The identifier information may be, for example, metadata and/or fingerprint of the data content. The metadata (referred to as content metadata) may be any data accompanying the data content, such as, for example, the content's title. The fingerprint (referred to as content fingerprint) may be a compact representation of the data content that uniquely identifies that content.

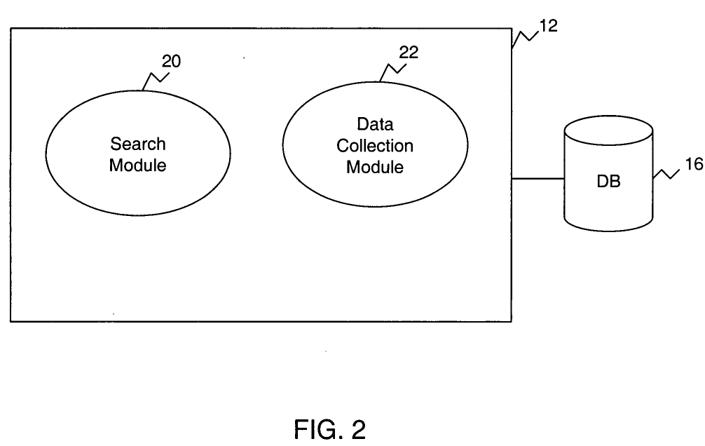

FIG. 2 is a more detailed block diagram of the server 12 according to one embodiment of the invention. The server 12 includes a search module 20 that receives content identifier information from a requesting end device, and searches the central database 16 for determining whether associated analysis data exists in the central database 16. The search module 20 transmits an appropriate response based on the determination. For example, the search module 20 may actually retrieve and transmit the identified analysis data to the requesting end device if the analysis data exists. Otherwise, the search module 20 may transmit a message indicating that the analysis data does not exist.

According to one embodiment of the invention, the server 12 also includes a data collection module 22 configured to receive analysis data transmitted by the various end devices 10. The analysis data is stored in the central database 16 in association with an identifier that identifies the content to which the analysis data relates.

According to one embodiment of the invention, the various modules 20, 22 are software modules implemented as computer program instructions that are stored in main memory and executed by one or more processors (not shown) included in the server 12. A person of skill in the art should recognize, however, that the modules may be implemented in hardware, firmware, or a combination of hardware, firmware, and/or software.

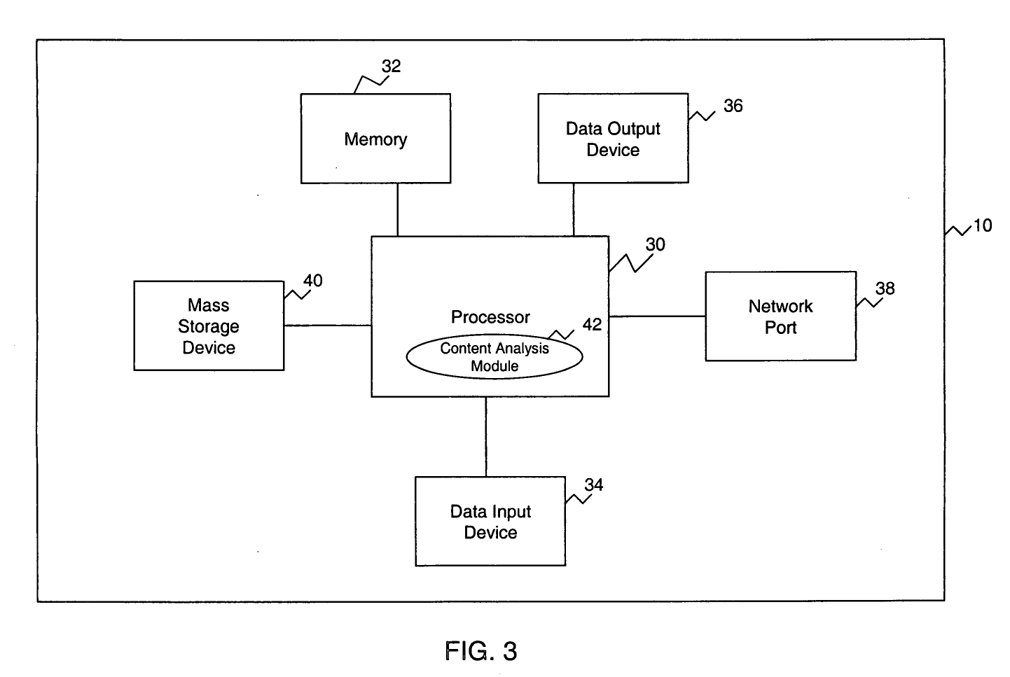

FIG. 3 is a detailed block diagram of an end user device 10 according to one embodiment of the invention. The device includes a processor 30, memory 32, data input device 34, data output device 36, network port 38, and mass storage device 40. The data input device 34 may include a keyboard, keypad, stylus, microphone, remote controller, and the like.

The data output device 36 may include a computer display screen, speakers, and the like. Pressure sensitive (touch screen) technology may also be incorporated into the display screen for allowing a user to provide additional data input by merely touching different portions of the display screen.

The mass storage device 40 includes a disk drive or drive array storing in one or more different files, content data owned by the user. Such content data may be, for example, music, recipes, lyrics, books, photos, images, and the like. Also stored in association with each content is content-identifying information such as, for example, content metadata, fingerprint, or the like, generated according any identifying mechanism known in the art.

In addition to the above, the mass storage device 40 may store content analysis data that is generated by the end device itself, or generated by another device and downloaded from the server 12. The analysis data may then be used for identifying other content, either in the mass storage device or in a remote server, that complements the content for which the analysis data was generated.

The network port 38 allows the end user device to connect to the data communications network 14 to upload or download analysis data to and from the server 12.

The memory 32 may include a read only memory, random access memory, flash memory, and the like. According to one embodiment of the invention, the memory includes computer instructions embodied as a content analysis module 42 which is loaded and executed by the processor 30 for identifying relevant data content stored in the memory 32 and/or the mass storage device 40, for intelligently analyzing the content, and for uploading the analysis data to the server 12. According to one embodiment of the invention, the processor 30 may download the content analysis module 42 from a server, such as, for example, the server 12, over the data communications network 14. Alternatively, the end device may be pre-configured with the content analysis module 42 prior to its sale.

According to one embodiment of the invention, intelligent content analysis may involve analysis of audio signals of an audio piece. In this regard, the content analysis module 42 is configured with an audio content analysis algorithm which determines the acoustic properties/attributes of the audio piece, such as, for example, tempo, repeating sections in the audio piece, energy level, presence of particular instruments (e.g. snares and kick drums), rhythm, bass patterns, harmony, particular music classes (e.g. jazz piano trio), and the like. The audio content analysis algorithm analyzes the audio signals and computes objective measurements of these acoustic properties as described in more detail in the above-referenced U.S. patent application Ser. No. 10/278,636. As the value of each acoustic property is computed, it is stored into an acoustic attribute vector as the audio description or acoustic analysis data. The acoustic attribute vector thus maps the calculated values to their corresponding acoustic attributes.

According to one embodiment of the invention, intelligent content analysis may also involve analysis of the ingredients in a recipe. In this regard, the content analysis module 42 is configured with a recipe analysis algorithm. The recipe analysis algorithm examines the ingredients in the recipe and determines one or more chemical compositions for each ingredient, as is described in more detail in U.S. Pat. No. 6,370,513, the content of which is incorporated herein by reference. Exemplary chemical compositions may include, for example, protein, fat, carbohydrate, sodium, sugar, potassium, water, caffeine, and the like. According to one embodiment, the recipe analysis algorithm parses the ingredients in the recipe, and searches a chemical database (not shown) that the end device may access via the data communications network 14, for the chemical compositions of each ingredient. If the ingredient is found, a value is set in a recipe vector to represent an amount of the chemical composition present in the ingredient. In doing so, certain chemical compositions may be given more weight than others. For example, chemical compositions which make greater contributions to an ingredient's taste are given higher weights than those that do not.

According to one embodiment of the invention, intelligent content analysis may also involve text analysis of text content, such as lyrics or books, for determining their properties or attributes. In this regard, the content analysis module 42 is configured with a text analysis algorithm. For example, the text analysis algorithm may parse the text and identify certain types of words, and/or frequency of such words. The text analysis may then be used to determine a value corresponding to a particular attribute, such as, for example, a reading level, style of speech, substance, and the like. A text vector is then generated for storing the value of each analyzed attribute.

According to yet another embodiment of the invention, intelligent content analysis may further involve analysis of paintings, other artworks, or images via an image analysis algorithm included in the content analysis module 42. For example, the image analysis algorithm may scan the painting, artwork, or image, and identify their colors, textures, and the like. A person of skill in the art should recognize that other types of content may be automatically analyzed, and the present invention is not limited to content analysis of music, recipes, lyrics, books, and paintings.

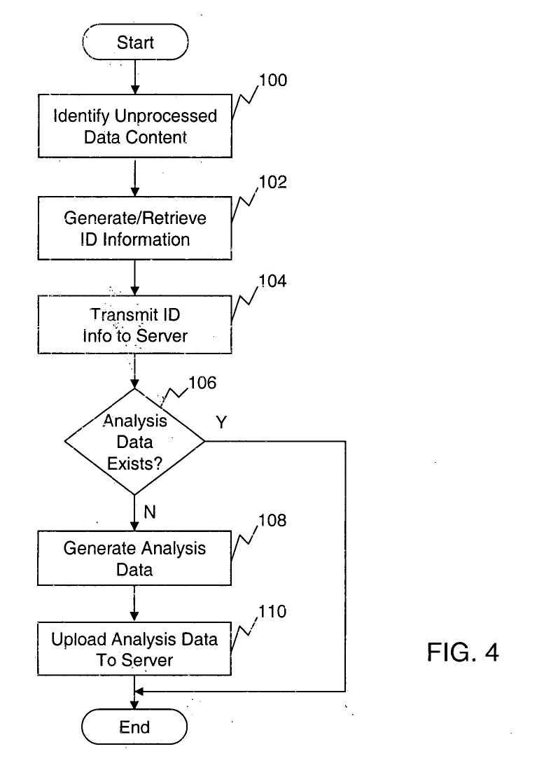

FIG. 4 is a flow diagram of a process executed by the content analysis module 42 for populating the central database 16 with intelligent content analysis data according to one embodiment of the invention.

In step 100, the processor 30 identifies unprocessed data content 100 stored in the memory 32 or mass storage device 40. In this regard, the end user may be asked to identify one or more folders that include data content to be processed. Any unprocessed data content in the identified folders is then processed according to steps 102-110. These folders are then monitored for determining whether new content has been added. Upon a detection of new content, steps 102-110 are automatically invoked for processing the content and generating its analysis data.

In another embodiment, steps 102-110 are invoked when the user manually selects the data content stored in the mass storage device and requests that it be analyzed. In yet another embodiment, steps 102-110 are invoked when the user selects the data content or a group in which the data content belongs, and requests for other complementary data content or group.

In step 102, the content analysis module 42 generates and/or retrieves identifying information for the unprocessed data content. For example, the processor may read a metadata tag accompanying the data content. The processor may also generate a fingerprint of the data content according to any fingerprinting algorithm known in the art, such as, for example, the fingerprinting algorithm described in the above-referenced U.S. application Ser. No. 10/668,926.

In step 104, the processor 30 transmits a request including the metadata and/or fingerprint information, to the search module 20 in the server 12. The search module 20 responds to the request by performing a lookup of the metadata and/or fingerprint information in the central database 16, and transmitting an appropriate response.

In step 106, a determination is made, based on the response from the search module 20, whether the requested analysis information exists in the central database 16. If the answer is NO, the content analysis module 42, in step 108, analyzes the unprocessed data content according to a content analysis algorithm, and generates analysis data for the data content.

In step 110, the content analysis module 42 uploads the analysis data to the data collection module 22 in the server 12, which then stores it in the central database 16.

Referring again to step 106, if the analysis data exists in the central database 16, this implies that some other end device already went through the task of analyzing the data content, making it unnecessary for the current end device to engage in the task. The current end device may thus simply download the analysis data for use by the end device.

According to one embodiment of the invention, the analysis data may be used for identifying other content that may complement the initial content for which analysis data was created. For example, if the initial content is music, its analysis data may be used for identifying other music pieces that complement the initial music. Also, if the content is a recipe, its analysis data may be used for identifying other recipes or foods complementing the initial recipe. Such a determination may be made, for example, by performing a vector distance computation between the analysis data of the initial content and the analysis data of each candidate content, and selecting one or more candidate contents whose vector distances are a predetermined distance to the initial content. Information may then displayed on the selected candidate contents. The selected candidate contents may also be retrieved and played and/or displayed for the user, or purchased and/or downloaded from a remote server.

It should be appreciated, therefore, that the various embodiments of the present invention allows geographically disperse data to be analyzed in a distributed manner, and the analysis data uploaded to a central repository. Because the server 12 is supplied with the analysis data, it need not, by itself, engage in costly processing to formulate the analysis. The supply of the analysis data by others who already own copies of the data also eliminates the need for the server to maintain copies of the actual data content. This allows the copyrights of the different data contents to be respected without limiting the generation of analysis data.

Although this invention has been described in certain specific embodiments, those skilled in the art will have no difficulty devising variations to the described embodiment which in no way depart from the scope and spirit of the present invention. For example, in addition to the end devices, other servers may also upload and download analysis data to and from the central database 16.

In addition, to those skilled in the various arts, the invention itself herein will suggest solutions to other tasks and adaptations for other applications. It is the Applicants' intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A distributed system for intelligent data analysis comprising:
a first computer device including a first data store storing first data content;
a second computer device including a second data store storing second data content; and
a central database coupled to the first and second computer devices over a data communications network, each computer device identifying the data content stored in its data store, communicating with the central database for determining whether the central database includes analysis information for the identified data content, and responsive to a determination that the central database does not include the analysis information, processing the corresponding data content according to stored processing instructions and generating corresponding analysis information, each computer device uploading the corresponding analysis information to the central database over the data communications network.

2. The system of claim 1, wherein the data content is a musical piece, and the processing of the data content includes analyzing audio signals of the musical piece for generating a numerical measurement for each of a plurality of predetermined acoustic attributes.

3. The system of claim 1, wherein the data content is a recipe, and the processing of the data content includes analyzing ingredients of the recipe for determining one or more chemical compositions and a numerical measurement of each of the one or more chemical compositions making up the ingredient.

4. The system of claim 1, wherein the data content is lyrics of a particular song.

5. The system of claim 1, wherein the data content is an image.

6. A server coupled to a plurality of end devices in a distributed system for intelligent data analysis, the server comprising:
a central data store;
a processor; and
a memory operably coupled to the processor and storing program instructions therein, the processor being operable to execute the program instructions, the program instructions including:
receiving from a first requesting end device a first request including identification information identifying particular data content;
responsive to the first request, searching the central data store for the identification information and determining whether the central data store includes analysis information for the particular data content;
receiving from the first requesting end device analysis information for the particular data content responsive to a determination that that the central data store does not include the analysis information; and
storing the received analysis information in the central data store.

7. The server of claim 6, wherein the program instructions further include:
receiving from a second requesting end device a second request including the identification information identifying the particular data content;
retrieving the analysis information from the central data store in response to the second request; and
forwarding the analysis information to the second requesting device.

8. The server of claim 6, wherein the particular data content is a particular musical piece and the analysis information includes acoustic analysis data, the acoustic analysis data being generated based on an automatic analysis of audio signals of the particular musical piece for generating a numerical measurement for each of a plurality of predetermined acoustic attributes.

9. The server of claim 6, wherein the particular data content is a recipe, and the analysis information includes recipe analysis data, the recipe analysis data being generated based on an analysis of each ingredient of the recipe for determining one or more chemical compositions and a numerical measurement of each of the one or more chemical compositions making up the ingredient.

10. The server of claim 6, wherein the particular data content is lyrics of a particular song.

11. The server of claim 6, wherein the particular data content is an image.

12. A method for intelligent data analysis comprising:
receiving from a first requesting end device a first request including identification information identifying particular data content;
responsive to the first request, searching the central data store for the identification information and determining whether the central data store includes analysis information for the particular data content;
receiving from the first requesting end device analysis information for the particular data content responsive to a determination that that the central data store does not include the analysis information; and
storing the received analysis information in the central data store.

13. The method of claim 12 further comprising:
receiving from a second requesting end device a second request including the identification information identifying the particular data content;
retrieving the analysis information from the central data store in response to the second request; and
forwarding the analysis information to the second requesting device.

14. The method of claim 12, wherein the particular data content is a particular musical piece and the analysis information includes acoustic analysis data, the acoustic analysis data being generated based on an automatic analysis of audio signals of the particular musical piece for generating a numerical measurement for each of a plurality of predetermined acoustic attributes.

15. The method of claim 12, wherein the particular data content is a recipe, and the analysis information includes recipe analysis data, the recipe analysis data being generated based on an analysis of each ingredient of the recipe for determining one or more chemical compositions and a numerical measurement of each of the one or more chemical compositions making up the ingredient.

16. The method of claim 12, wherein the particular data content is lyrics of a particular song.

17. The method of claim 12, wherein the particular data content is an image.
